(19) United States
(12) Patent Application Publication
(10) Pub. No.: US 2026/0178353 A1
(43) Pub. Date: Jun. 25, 2026

(54) APPARATUSES, COMPUTER-IMPLEMENTED METHODS, AND SYSTEMS FOR OUTPUTTING A DEFERRED WORKSPACE IDENTIFICATION INTERFACE COMPONENT IN ASSOCIATION WITH AN EMBEDDED APPLICATION

(71) Applicant: ATLASSIAN PTY LTD., Sydney (AU)

(72) Inventors: Connor DeYoung, Austin, TX (US); Patrick Evan Little, Monroe, WA (US); Tyler Wilman, Vancouver (CA); Elsie Ruoxi Wang, New York, NY (US); Marie Casabonne, Berkeley, CA (US)

(21) Appl. No.: 19/000,876

(22) Filed: Dec. 24, 2024

(51) Int. Cl. G06F 9/451; G06F 3/0482; G06Q 10/10

(52) U.S. Cl. CPC G06F 9/451; G06F 3/0482; G06Q 10/103

(57) ABSTRACT

Methods, apparatuses, systems, and computer program products are disclosed for outputting deferred workspace identification interface component(s) in a project management and collaboration system. In an example embodiment, an apparatus is caused to receive an embedded application content creation request in response to user interaction with a user-accessed application user interface rendered in a user-accessed application instance, cause generation of an embedded application content data object, programmatically assign the embedded application content data object to a workspace data structure, generate a deferred workspace identification interface component comprising an identification of the workspace data structure, and output the deferred workspace identification interface component for rendering to an embedded application user interface displayed in association with the user-accessed application instance.

### CROSS REFERENCE TO RELATED APPLICATION

This application is related to commonly-owned U.S. Pat. No. 11,044,348, filed on Nov. 5, 2020, as U.S. patent application Ser. No. 17/090,648, and is entitled “SYSTEM, METHOD, AND COMPUTER PROGRAM PRODUCT FOR IMPROVED EMBEDDED APPLICATION DATA MANAGEMENT,” which patent is incorporated by reference herein in its entirety.

### TECHNOLOGICAL FIELD

Embodiments of the present disclosure generally relate to an improved framework for supporting data interoperability between software applications, and specifically to outputting a deferred workspace identification interface component for rendering to an embedded application user interface displayed in association with a user-accessed application.

### BACKGROUND

Various methods, apparatuses, and systems provide tools for users to plan, coordinate, track, manage, collaborate, and/or otherwise monitor projects and tasks in project management and collaboration systems. Applicant has identified a number of deficiencies and problems associated with intelligently and efficiently determining a relevant storage space when creating an instance of a discrete software application embedded within another software application. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, systems, computer program products, and/or the like configured for effectively and efficiently outputting deferred workspace identification interface component(s) in a project management and collaboration system. In accordance with one exemplary embodiment of the present disclosure, an apparatus is provided for outputting a deferred workspace identification interface component in a project management and collaboration system. The apparatus comprises at least one processor, and at least one memory including program code, the at least one memory and the program code configured to, with the at least one processor, cause the apparatus to receive an embedded application content creation request in response to user interaction with a user-accessed application user interface rendered in a user-accessed application instance; cause generation of an embedded application content data object; programmatically assign the embedded application content data object to a workspace data structure; generate a deferred workspace identification interface component comprising an identification of the workspace data structure; and output the deferred workspace identification interface component for rendering to an embedded application user interface displayed in association with the user-accessed application instance.

In some embodiments, the embedded application content creation request comprises a project identifier associated with the user-accessed application instance. In some further embodiments, programmatically assigning the embedded application content data object comprises in an instance wherein the project identifier is associated with a project workspace data structure, assigning the embedded application content data object to the project workspace data structure; and in an instance wherein the project identifier is not associated with a project workspace data structure, assign the embedded application content data object to a user workspace data structure.

In some embodiments, the deferred workspace identification interface component is configured to provide an interactive workspace data structure input interface element, the interactive workspace data structure input interface element configured to enable user input of at least one changed workspace data structure. In some further embodiments, the interactive workspace data structure input interface element comprises a drop-down menu, the drop-down menu comprises a workspace data structure suggestion set, and the workspace data structure suggestion set comprises the workspace data structure and one or more potential changed workspace data structures.

In some embodiments, the embedded application user interface is an embedded application editor user interface configured for receiving user edits to the embedded application content data object.

In some embodiments, the at least one memory and the program code are further configured to, with the at least one processor, cause the apparatus to at least receive a publish embedded application content data object request; generate a confirm workspace identification interface component comprising an identification of the workspace data structure; and output the confirm workspace identification interface component for rendering to the embedded application user interface. In some further embodiments, the confirm workspace identification interface component is configured to provide an interactive workspace data structure input interface element, the interactive workspace data structure input interface element configured to enable user input of at least one changed user workspace data structure.

In one embodiment, the at least one memory and the program code are further configured to, with the at least one processor, cause the apparatus to at least receive a change workspace data structure request comprising a workspace identifier; and programmatically assign the embedded application content data object to a changed workspace data structure associated with the workspace identifier.

In some embodiments, the at least one memory and the program code are further configured to, with the at least one processor, cause the apparatus to at least receive a confirm embedded application content data object publication request; generate a workspace publication confirmed interface component comprising an identification of the workspace data structure; and output the workspace publication confirmed interface component for rendering to the embedded application user interface. In some further embodiments, the embedded application content data object is assigned a first accessibility type when generated, and wherein the at least one memory and the program code are further configured to, with the at least one processor, cause the apparatus to at least cause updating of the first accessibility type to a second accessibility type.

In another embodiment, a computer-implemented method for outputting a deferred workspace identification interface component in a project management and collaboration system is disclosed, the method comprising receiving an embedded application content creation request in response to user interaction with a user-accessed application user interface rendered in a user-accessed application instance; causing generation of an embedded application content data object; programmatically assigning the embedded application content data object to a workspace data structure; generating a deferred workspace identification interface component comprising an identification of the workspace data structure; outputting the deferred workspace identification interface component for rendering to an embedded application user interface displayed in association with the user-accessed application instance; receiving a publish embedded application content data object request; generating a confirm workspace identification interface component comprising an identification of the workspace data structure; and outputting the confirm workspace identification interface component for rendering to the embedded application user interface.

In some embodiments, the embedded application content creation request comprises a project identifier associated with the user-accessed application instance.

In some embodiments, programmatically assigning the embedded application content data object comprises in an instance wherein the project identifier is associated with a project workspace data structure, assigning the embedded application content data object to the project workspace data structure; and in an instance wherein the project identifier is not associated with a project workspace data structure, assign the embedded application content data object to a user workspace data structure.

In some embodiments, the deferred workspace identification interface component is configured to provide an interactive workspace data structure input interface element, the interactive workspace data structure input interface element configured to enable user input of at least one changed workspace data structure. In some further embodiments, the interactive workspace data structure input interface element comprises a drop-down menu, the drop-down menu comprises a workspace data structure suggestion set, and the workspace data structure suggestion set comprises the workspace data structure and one or more potential changed workspace data structures.

In some embodiments, the embedded application user interface is an embedded application editor user interface configured for receiving user edits to the embedded application content data object.

In some embodiments, the confirm workspace identification interface component is configured to provide an interactive workspace data structure input interface element, the interactive workspace data structure input interface element configured to enable user input of at least one changed user workspace data structure.

In another embodiment, a computer program product, stored on a non-transitory computer readable storage medium, comprising instructions that when executed by one or more processors cause the one or more processors to receive an embedded application content creation request in response to user interaction with a user-accessed application user interface rendered in a user-accessed application instance; cause generation of an embedded application content data object; programmatically assign the embedded application content data object to a workspace data structure; generate a deferred workspace identification interface component comprising an identification of the workspace data structure; and output the deferred workspace identification interface component for rendering to an embedded application user interface displayed in association with the user-accessed application instance, wherein the embedded application user interface is associated with an embedded application instance and wherein the user-accessed application instance and the embedded application instance define separate executable code bases.

In some embodiments, the user-accessed application instance defines a first executable code base that performs a particular first set of functions and is configured to provide a second set of functions associated with the embedded application instance embodied by a second executable code base.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE SEVERAL VIEWS OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings:

FIG. 1 illustrates an example project management and collaboration system configured to communicate with various client devices in accordance with various example embodiments described herein;

FIG. 2 is a schematic block diagram of example circuitry to perform various operations in accordance with various embodiments of the subject disclosure;

FIG. 3 illustrates an example user-accessed application user interface structured in accordance with example embodiments of the subject disclosure;

FIGS. 4A and 4B illustrate example deferred workspace identification interface components structured in accordance with example embodiments of the subject disclosure;

FIGS. 5A and 5B illustrate example confirm workspace identification interface components structured in accordance with example embodiments of the subject disclosure;

FIGS. 6A and 6B illustrate example workspace publication confirmed interface components structured in accordance with example embodiments of the subject disclosure;

FIG. 7A is a flowchart illustrating example operations for outputting a deferred workspace identification interface component in accordance with various aspects and embodiments of the subject disclosure; and

FIG. 7B is a signal diagram of an example data flow in accordance with various aspects and embodiments of the subject disclosure.

### DETAILED DESCRIPTION

One or more embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard). It should be understood that some, but not all embodiments are shown and described herein. Indeed, the embodiments may be embodied in many different forms, and accordingly this disclosure should not be construed as limited to the embodiments set forth herein. Rather, these embodiments are provided so that this disclosure will satisfy applicable legal requirements. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

### Overview

Methods, apparatuses, systems, and computer program products are provided in accordance with example embodiments of the present disclosure in order to address technical problems associated with generating and providing an improved deferred workspace identification interface component to an embedded application interface when causing generation of an embedded application content data object within a user-accessed application instance in, for example, a project management and collaboration system.

Individuals and organizations routinely use a project management and collaboration system to enable an individual user or group(s) of users to plan, track, organize, schedule, collaborate, and/or otherwise manage one or more development projects, such as agile software development projects. Certain software applications in a project management and collaboration system may be developed to enable interaction(s) and/or data interoperability with other software applications. For example, a first software application may be designed to call, or retrieve data from, a second software application to accomplish various tasks or operations in a project management and collaboration system. Such interaction(s) are especially useful in circumstances where the first software application and the second software application have a common owner, are provided in a common software suite or tool kit, and/or otherwise where use of the second software application is to be incentivized.

Conventional “siloing” of software applications, however, can continue to create user experience issues and technical challenges with efforts to achieve true interoperability and seamlessly share content with other users across such software applications, even in instances of embedded applications. For example, interoperability-based technical problems may arise based on the use of particular mechanisms for facilitating communication between the two discrete software applications. Technical challenges may arise in such instances due to dedicated and distinct data repositories for each application. For example, issues may arise when users try to create an instance of the embedded, second software application accessible through the first, user-accessed software application due to such interoperability-based technical problems, including issues related to selecting a space in which to store the data object being created in the embedded application. This may be due to a search user interface and/or search capabilities between the first and second software applications, which result in suggested spaces that are irrelevant to the user and/or the underlying project.

Embodiments of the present disclosure address the various deficiencies set forth above and others described herein by removing the friction between such applications and seamlessly creating such content data object and programmatically assigning it to a relevant workspace. In some embodiments of the present disclosure, a user-accessed application (e.g., Jira Software® (JSW) by Atlassian, Jira Service Management® (JSM) by Atlassian, Jira Work Management® (JWM) by Atlassian, Trello® by Atlassian, etc.) is provided. In some embodiments, a user desires to include or otherwise associate an underlying project of the user-accessed application with an embedded application (e.g., Confluence® by Atlassian) with which the user-accessed application may interact. A data-driven connection is established and/or otherwise associated with the user-accessed application that enables interoperability between the user-accessed application and the embedded application. In this regard, in some embodiments, the data-driven connection enables functionality of the embedded application to be performed via the user-accessed application. The user-accessed application operates as a back-end and is hosted by a server. The user-accessed application is configured to communicate with and otherwise support a user-facing application (e.g., a client-side app) that operates as a front-end at the client or user device. In various embodiments, a user may access functionality of both the user-accessed application and the embedded application via a single point of interaction (i.e., via the user-facing application launched at the client).

Consider, for example, a JSW user who desires to create an embedded Confluence page within a Jira project instance. For example, Andy, who works as a software developer for developing a particular software tool, Beta Accounting Software (“Beta”), desires to create an embedded Confluence page within a Jira project instance so that at least some functionality of the embedded application (e.g., Confluence®) is made accessible from within JSW. In this regard, certain functionality and features of Confluence® are “embedded” within the JSW instance made available to Andy. In one embodiment, JSW is configured to provide access to certain Confluence® content collaboration functionality, such as creating new pages, updating page content, and/or sharing page content. Such functionality is powered by Confluence® but made available all from within a launched instance of JSW, such that Andy may utilize such functionality from within his JSW instance. Example embodiments of the present disclosure address improved workspace data structure selection for such embedded application content data objects, such as a Confluence® page, including improved programmatic determination and assignment to a relevant workspace data structure for the user. Such embodiments, for example, make creating such embedded content data object in the user-accessed application seamless by removing the friction of forced space selection prior to creation and search capabilities that are hindered by siloed data between the applications.

It should be appreciated that embodiments disclosed herein provide for user-accessed applications and embedded applications in any of a myriad of contexts. In some example contexts, for example, the embedded application and the user-accessed application may be controlled by a single entity or otherwise part of a single suite of software tools. In another context, an embedded application and a user-accessed application may be controlled by separate entities. For example, an entity controlling a user-accessed application may enable access to functionality of an embedded application controlled by another entity for any of a myriad of business reasons (e.g., to increase revenue by incentivizing use of advanced features requiring payment by a user) and/or technical reasons (e.g., to provide access to complementary functionality upon which the embedded application is based). In this regard, it should be appreciated that example embodiments may be configured as described herein to provide interoperability between a user-accessed application and an embedded application in a manner that provides an improvement to the field of interoperable application data management, as described herein.

Accordingly, systems structured in accordance with various embodiments of the present disclosure may provide specific, technical solutions to technical problems faced by existing systems, the details of which are described hereafter.

### Definitions

As used herein, the term “project management and collaboration system” refers to the software platform(s) and associated hardware that is configured to support and maintain a plurality of projects, programs, workflows, tools and all associated functionality. For example, a non-limiting example of a project management and collaboration system may comprise one or more software products such as Jira Software®, Jira Work Management®, or Confluence® by Atlassian®. Example project management and collaboration systems comprise supporting server(s), repositor(ies), and client devices, and in some embodiments, are further configured to engage with internal resources, external resources, internal applications, and/or external applications.

The term “deferred workspace identification management server” refers to a software platform and associated hardware that is configured to, inter alia, receive embedded application content creation request(s), publish embedded application content data object request(s), confirm embedded application content data object publication request(s), change workspace data structure request(s), and/or the like, access (and/or direct the access of) a variety of data repositor(ies) (e.g., a deferred workspace identification repository, a user-accessed application repository, and/or an embedded application repository), programmatically assign embedded application content data objects to workspace data structures, determine workspace data structure suggestion set(s), and generate and/or manage the various interfaces and/or interface components (e.g., deferred workspace identification interface components, confirm workspace identification interface component, workspace publication confirmed interface component, user-accessed application user interface, embedded application user interface, etc.) and associated functionality of the project management and collaboration system. For example, in some embodiments, the deferred workspace identification management server is configured to generate, output, update and/or otherwise manage deferred workspace identification interface component(s), interactive workspace data structure input interface element(s), confirm workspace identification interface component(s), workspace publication confirmed interface component(s), and/or the like.

The deferred workspace identification management server is accessible via one or more computing devices, is configured to receive various requests (e.g., embedded application content creation request(s), publish embedded application content data object request(s), confirm embedded application content data object publication request(s), change workspace data structure request(s), and/or the like), and access (and/or direct the access of) one or more data repositories, such as a deferred workspace identification repository, a user-accessed application repository, and/or an embedded application repository. The functionality of the deferred workspace identification management server may be provided via a single server or collection of servers having a common functionality, or the functionality of the deferred workspace identification management server may be segmented among a plurality of servers or collections of servers (e.g., microservices) performing subsets of the described functionality of the deferred workspace identification management server.

As used herein, the term “deferred workspace identification repository” refers to a location, such as a database stored on a memory device, which is accessible by one or more computing devices for retrieval and storage of data associated with the project management and collaboration system. For example, the deferred workspace identification repository may include data associated with the deferred workspace identification management server and/or the like. The deferred workspace identification repository may be a dedicated device and/or part of a larger repository. The deferred workspace identification repository dynamically updated or may be static. In some embodiments, the deferred workspace identification repository encrypted in order to limit unauthorized access of data associated with the project management and collaboration system.

As used herein, the term “user-accessed application repository” refers to a location, such as a database stored on a memory device, which is accessible by one or more computing devices for retrieval and storage of data associated with the project management and collaboration system. For example, the user-accessed application repository may include data associated with the user-accessed application (e.g., user-accessed application objects, project identifier, team identifier, team member identifiers, workspace identifiers, etc.) and/or the like. The user-accessed application repository may be a dedicated device and/or part of a larger repository. The user-accessed application repository may be dynamically updated or may be static. In some embodiments, the user-accessed application repository is encrypted in order to limit unauthorized access of data associated with the project management and collaboration system.

As used herein, the term “embedded application repository” refers to a location, such as a database stored on a memory device, which is accessible by one or more computing devices for retrieval and storage of data associated with the project management and collaboration system. For example, the embedded application repository may include data associated with the embedded application (e.g., embedded application objects, workspace identifiers, user identifiers, etc.) and/or the like. The embedded application repository may be a dedicated device and/or part of a larger repository. The embedded application repository may be dynamically updated or may be static. In some embodiments, the embedded application repository is encrypted in order to limit unauthorized access of data associated with the project management and collaboration system.

The term “embedded” with respect to a particular application refers to a combination of functionality and corresponding user interface(s) displayed in association with or otherwise presented from within an instance of a first software application (e.g., a user-accessed application). In some embodiments, such separate applications are associated with a different set of provisioned user accounts and/or dedicated and distinct data repositories for each application, such that functionality made available via embedding is controlled by each of the separate applications from within the user-accessed application as described herein.

The term “executable code base” refers to computer program code stored in one or a plurality of locations that is executed and/or executable via one or more computer devices embodied in hardware, software, firmware, and/or any combination thereof. An executable code base defines at least one particular application to be executed by one or more computing devices. In some embodiments, a memory, storage, and/or other computing device includes and/or otherwise is structured to define any number of separate executable code bases (e.g., a first application and a second application, a user-accessed application and an embedded application, or the like). Alternatively or additionally, in some embodiments, separate executable code bases are embodied by separate computing devices (e.g., a first server embodying a first executable code base and a second server embodying a second executable code base).

The term “user-accessed application” refers to a first executable code base that performs a particular first set of functions and is configured to provide a second set of functions associated with an embedded application embodied by a second executable code base through interaction via a connection associated with the embedded application, such as a data-driven connection. For example, the user-accessed application may embed functions of an embedded application within an integrated interface (e.g., an embedded application user interface displayed in association with a user-accessed application instance) along with native functions of the user-accessed application. The data-driven connection is a configuration and/or mechanism (e.g., a library of one or more application programming interface(s) (APIs) configured for enabling such interaction) by which a user-accessed application is enabled to access embedded app data object(s) and/or associated functionality provided by an embedded application. In some embodiments, the corresponding embedded application user interface is displayed in association with or otherwise presented from within an instance of the user-accessed application. A user-accessed application is associated with a first set of user accounts that are provisioned to enable access to the functionality provided by the user-accessed application.

In some embodiments, the user-accessed application is a project management application or project management-type application which may be a dedicated software program, application, platform, service, web browser, or computer-executable application software programmed or configured to run on a client device which provides the user access to the project management and collaboration system and its associated functionality. In some embodiments, the project management application may include hardware, software, or combinations thereof operating remotely (e.g., on a server). In some embodiments, the project management application is designed to execute on mobile devices, such as tablets or smartphones. For example, in certain embodiments, an app is provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

The term “embedded application” refers to an executable code base that performs a particular second set of functions and is configured to be accessed at least through a user-accessed application associated with a separate executable code base from that of the embedded application. For example, functionality associated with an embedded application may be embedded into an integrated interface comprising functionality of a user-accessed application. In some embodiments, the corresponding embedded application user interface is displayed in association with or otherwise presented from within an instance of the first software application (e.g., a user-accessed application). An embedded application is associated with a second set of user accounts that are provisioned to enable access to the functionality provided by the embedded application. In some embodiments, an embedded application is accessible directly as well as through a user-accessed application. Further details regarding user-accessed applications, embedded applications, data-driven connections, and otherwise provisioning embedded application access are described in commonly-owned U.S. Pat. No. 11,044,348, which was filed as U.S. application Ser. No. 17/090,648 on Nov. 5, 2020, and is entitled “SYSTEM, METHOD, AND COMPUTER PROGRAM PRODUCT FOR IMPROVED EMBEDDED APPLICATION DATA MANAGEMENT”, which patent is incorporated by reference herein in its entirety.

The term “user interface” or “user-accessed application user interface” refers to a graphical user interface of a user-accessed application. In some embodiments, a user-accessed application user interface is configured to enable users to view and engage with one or more project management workspaces (e.g., such as a Jira Software workspace). A user-accessed application user interface is rendered to a client device based on data and instructions provided by the user-accessed application and/or the project management and collaboration system (e.g., deferred workspace identification management server). In some embodiments, such data and instructions are facilitated by a dedicated software application running on the client device. In other embodiments, such data and instructions are provided through a web browser running on the client device.

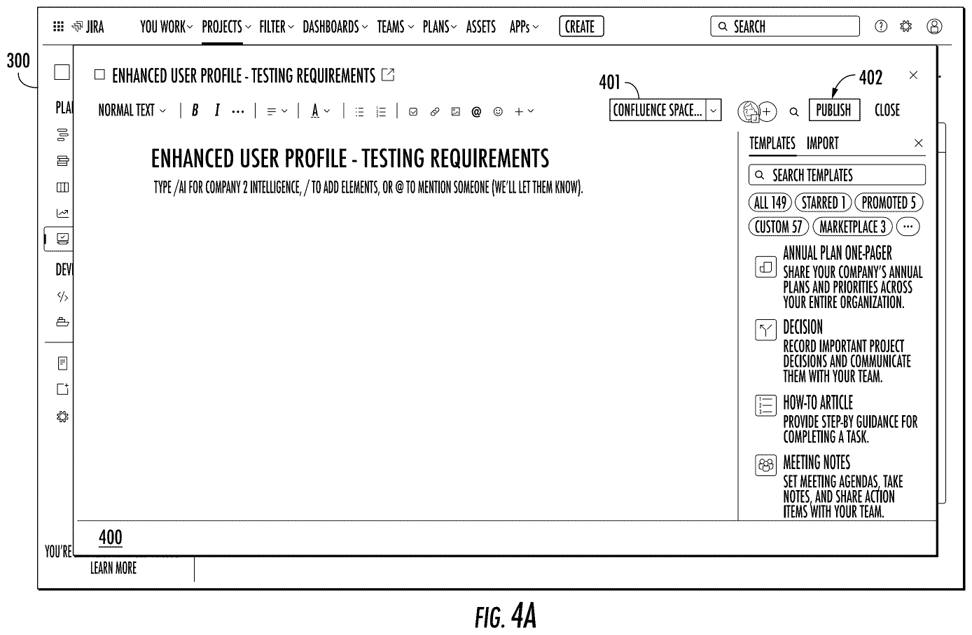

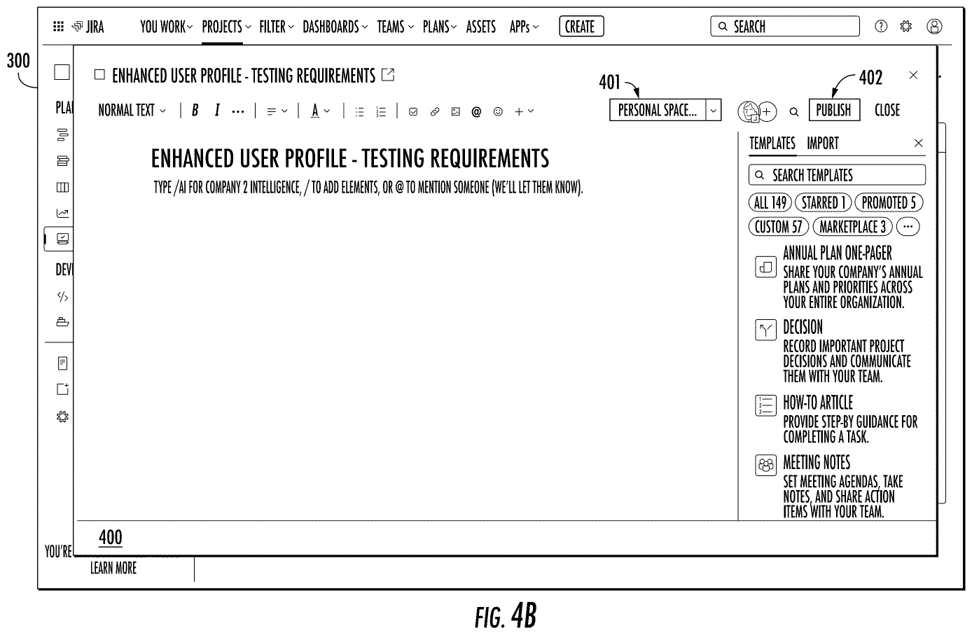

The term “deferred workspace identification interface component” refers to a user interface element that is rendered to, or as a portion of, a graphical user interface (e.g., as part of an embedded application user interface displayed in association with an underlying user-accessed application instance) in a project management and collaboration system and is configured to receive user interaction and to display identification of a programmatically assigned workspace data structure. A non-limiting example of a deferred workspace identification interface component is set forth as 401 in FIGS. 4A and 4B.

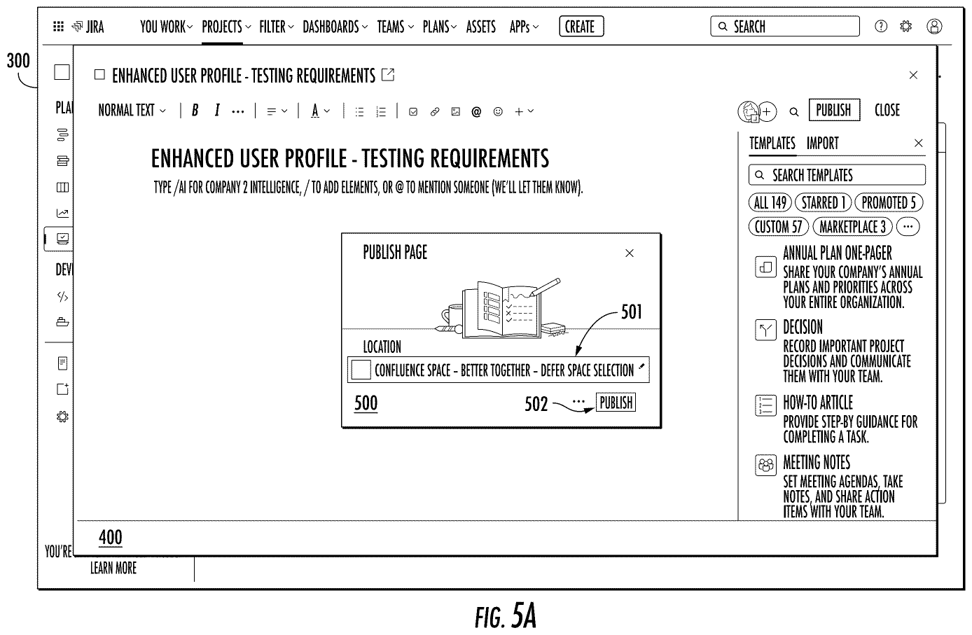

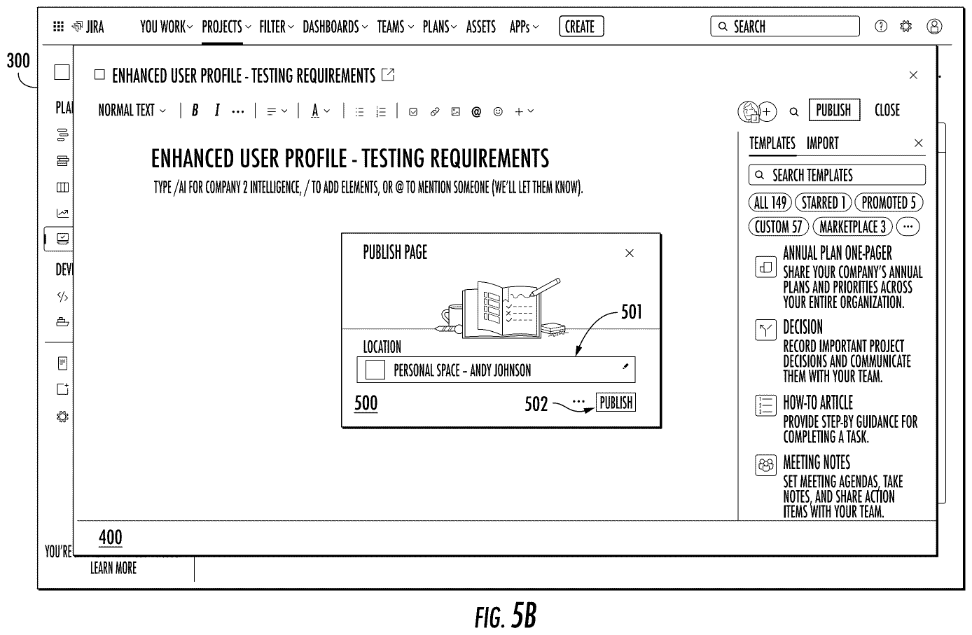

The term “confirm workspace identification interface component” refers to a user interface component that is rendered to, or as a portion of, a graphical user interface (e.g., as part of an embedded application user interface displayed in association with an underlying user-accessed application instance) in a project management and collaboration system and is configured to receive user interaction and to display identification of a workspace data structure to which the embedded application content data object is currently assigned. A non-limiting example of a confirm workspace identification interface component is set forth as 500 in FIGS. 5A and 5B.

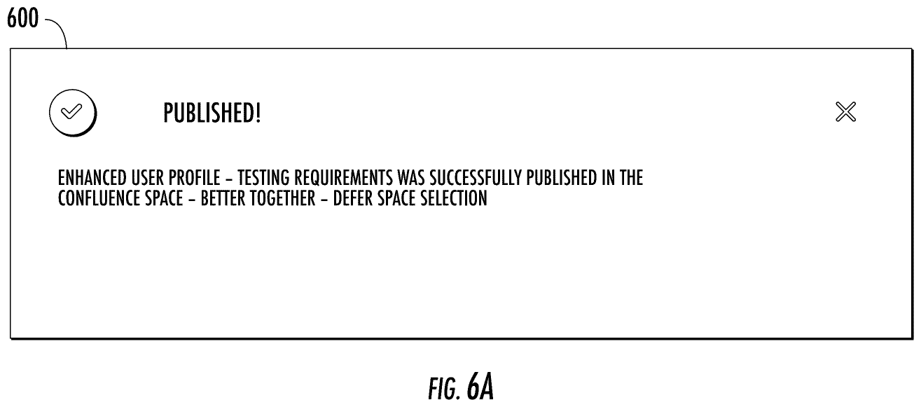

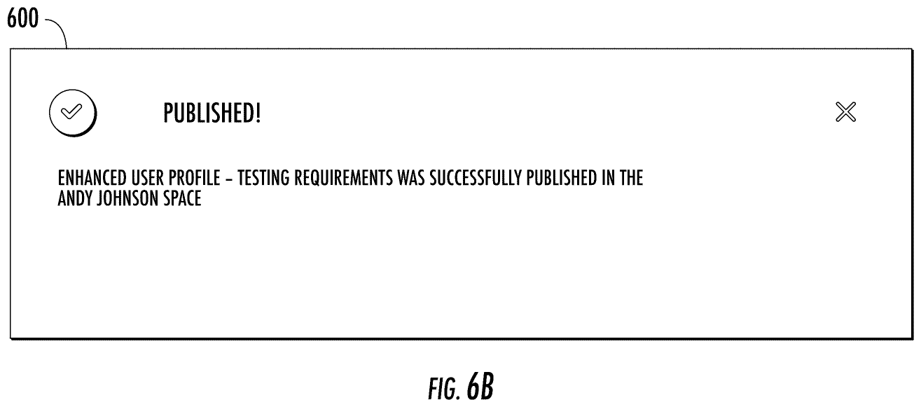

The term “workspace publication confirmed interface component” refers to a user interface component that is rendered to, or as a portion of, a graphical user interface (e.g., as part of an embedded application user interface displayed in association with an underlying user-accessed application instance) in a project management and collaboration system and is configured to display confirmation and identification of the content data object being published and to which workspace data structure the embedded application content data object was published. A non-limiting example of a workspace publication confirmed interface component is set forth as 600 in FIGS. 6A and 6B.

The term “embedded application content creation request” refers to an electrically generated digital object created by a computing device that indicates that a user has provided an input comprising a request to generate an embedded application content data object. In some embodiments, the embedded application content creation request is associated with a project identifier and/or the like. An embedded application content creation request may be represented via a temporary code that notifies a recipient (e.g., a server) that a user (e.g., a user of the user-accessed application) has made the request. To provide further context, an embedded application content creation request is generated in response to a user interaction with a computing device wherein a user causes the computing device to generate an embedded application content creation request. For example, in some embodiments, the user interacts with, for example, a specific actuator button (e.g., “Create”, “Page”, “Whiteboard”, and/or the like) rendered on a visual display of the computing device in association with the user-accessed application user interface.

The term “workspace data structure suggestion set” refers to a set of suggested workspace data structures identified as potential changed or alternative workspace data structures to the workspace data structure that is programmatically assigned to the generated embedded application content data object.

The term “embedded application content data object” refers to a digital or electronic document in which any of a variety of information, ideas, and knowledge data may be stored, such as, but not limited to, project documentation, meeting notes, team updates, knowledge sharing, troubleshooting guides, policies, etc. Embedded application content data object may be associated with a content data object identifier, such as a page identifier, and may be organized hierarchically. An embedded application content data object may include data in any one or more forms such as text, images, tables, code, whiteboards, databases, videos, design files, code repositories, spreadsheets, and/or the like. An embedded application content data object may be structured in a variety of ways and in some instances may be based on one or more templates. A non-limiting example of an embedded application content data object is a Confluence® page.

The term “workspace data structure” refers to an electronic container in which content data objects associated with an embedded application and/or a standalone instance of the embedded application may be stored. In some embodiments, a project of a user-accessed application may be associated with a workspace data structure. For example, a project identifier of a project of a user-accessed application may be associated with (e.g., stored in association with) a workspace identifier of a workspace data structure. Such a project-linked workspace data structure is referred to as a “project workspace data structure”. In some embodiments, a user of a user-accessed application may be assigned or associated with a personal workspace data structure. For example, a user identifier of a user of a user-accessed application may be associated with (e.g., stored in association with) a workspace identifier of a workspace data structure. Such a user-linked workspace data structure is referred to as a “user workspace data structure”. Other types of workspace data structures are encompassed by this disclosure, including, for example, a team workspace data structure, an initiative data structure, and/or the like.

The term “publish embedded application content data object request” refers to an electrically generated digital object created by a computing device that indicates that a user has provided an input comprising a request to publish an embedded application content data object. A publish embedded application content data object request may be represented via a temporary code that notifies a recipient (e.g., a server) that a user (e.g., a user of the embedded application accessed via the user-accessed application) has made the request. To provide further context, a publish embedded application content data object request is generated in response to a user interaction with a computing device wherein a user causes the computing device to generate a publish embedded application content data object request. For example, in some embodiments, the user interacts with, for example, a specific actuator button (e.g., “Publish”, and/or the like) rendered on a visual display of the computing device in association with an embedded application user interface (e.g., an embedded application editor user interface).

The term “confirm embedded application content data object publication request” refers to an electrically generated digital object created by a computing device that indicates that a user has provided an input comprising a request to publish an embedded application content data object after having the opportunity to confirm the workspace data structure to which the embedded application content data object is to be published. A confirm embedded application content data object publication request may be represented via a temporary code that notifies a recipient (e.g., a server) that a user (e.g., a user of the embedded application accessed via the user-accessed application) has made the request. To provide further context, a confirm embedded application content data object publication request is generated in response to a user interaction with a computing device wherein a user causes the computing device to generate a confirm embedded application content data object publication request. For example, in some embodiments, the user interacts with, for example, a specific actuator button (e.g., “Publish”, and/or the like) rendered on a visual display of the computing device in association with a confirm workspace identification interface component.

The terms “project identifier” or “project ID” refer to one or more items of data by which a project may be uniquely identified within a project management and collaboration system. For example, a project identifier may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

The terms “team member identifier” or “team member ID” refer to one or more items of data by which a team member may be uniquely identified within a project management and collaboration system. For example, a team member identifier may comprise one or more of ASCII text, encryption keys, identification certificates, a pointer, an IP address, a URL, a MAC address, a memory address, or other unique identifier, or combinations thereof.

The terms “team identifier” or “team ID” refer to one or more items of data by which a team may be uniquely identified within a project management and collaboration system. For example, a team identifier may comprise one or more of ASCII text, encryption keys, identification certificates, a pointer, an IP address, a URL, a MAC address, a memory address, or other unique identifier, or combinations thereof.

The terms “workspace identifier” or “workspace ID” refer to one or more items of data by which a workspace may be uniquely identified within a project management and collaboration system. For example, a team identifier may comprise one or more of ASCII text, encryption keys, identification certificates, a pointer, an IP address, a URL, a MAC address, a memory address, or other unique identifier, or combinations thereof.

The terms “user identifier” or “user ID” refer to one or more items of data by which a user may be uniquely identified within a project management and collaboration system. For example, a user identifier may comprise one or more of ASCII text, encryption keys, identification certificates, a pointer, an IP address, a URL, a MAC address, a memory address, or other unique identifier, or combinations thereof.

The terms “user interaction” or “user engagement” refer to user interaction, via a graphical user interface, with an interface, interface components, or elements thereof. Such user engagement or user interaction with the interface, interface components, or elements thereof can be via a multitude of interactions, such as, but not limited to, “non-keystroke engagement” or “keystroke engagement.” Non-keystroke engagement refers to user interaction in which such user interaction is free from (i.e., excludes) the entering of one or more (e.g., keystroke) characters into a user interface. For example, touch-screen or mouse click engagement are examples of non-keystroke engagement. The term “keystroke engagement” refers to entering of one or more keystrokes into a component of the interface. For example, input of one or more characters (e.g., alphanumeric characters or emojis) into a component of the interface is one example of keystroke engagement.

As used herein, the terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

Terms such as “computing,” “determining,” “generating,” and/or similar words are used herein interchangeably to refer to the creation, modification, or identification of data.

The term “computer-readable storage medium” refers to a non-transitory, physical or tangible storage medium (e.g., volatile or non-volatile memory), which may be differentiated from a “computer-readable transmission medium,” which refers to an electromagnetic signal.

The term “client device” and similar terms refer to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

The terms “database,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSqL database (e.g., DynamoDB), and/or the like.

The term “comprising” means including but not limited to and should be interpreted in the manner it is typically used in the patent context. Use of broader terms such as comprises, includes, and having should be understood to provide support for narrower terms such as “consisting of,” “consisting essentially of,” and “comprised substantially of”.

The phrases “in one embodiment,” “according to one embodiment,” “in some embodiments,” and the like generally mean that the particular feature, structure, or characteristic following the phrase may be included in the at least one embodiment of the present disclosure and may be included in more than one embodiment of the present disclosure. Thus, the particular feature, structure, or characteristic may be included in more than one embodiment of the present disclosure such that these phrases do not necessarily refer to the same embodiment. Further, “based on,” “based at least in part on,” “based at least on,” “based upon,” and/or similar words are used herein interchangeably in an open-ended manner such that they do not indicate being based only on or based solely on the referenced element or elements unless so indicated.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such a component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “set” refers to a collection of one or more items.

The term “plurality” refers to two or more items.

The term “or” is used herein in both the alternative and conjunctive sense, unless otherwise indicated.

### Example System Architecture

Methods, apparatus, and computer program products of the present disclosure may be embodied by any of a variety of computing devices. For example, the method, apparatus, and computer program product of an example embodiment may be embodied by a networked device (e.g., an enterprise platform), such as a server or other network entity, configured to communicate with one or more devices, such as one or more client devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

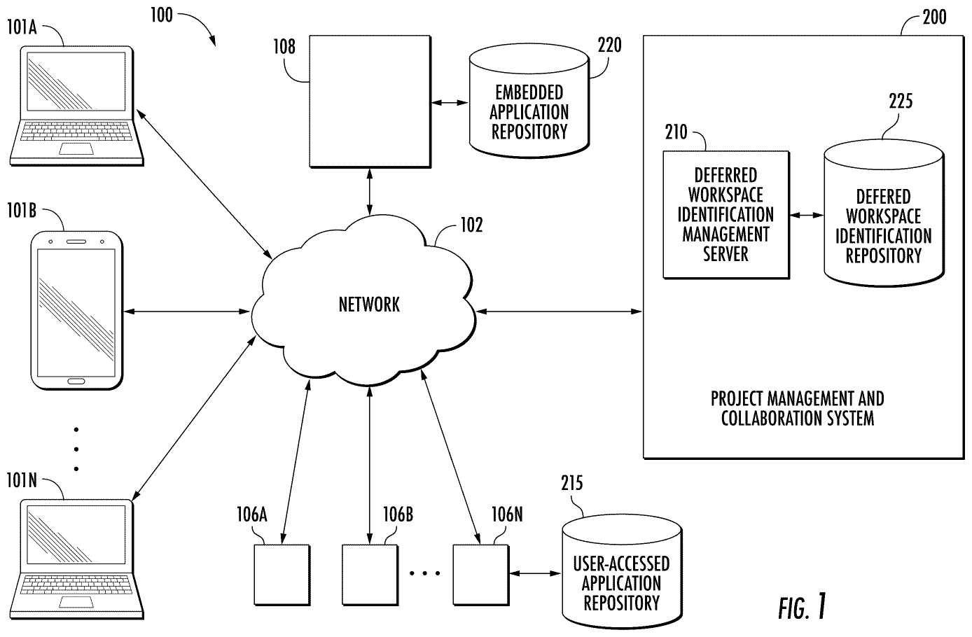

With reference to FIG. 1, an example computing system 100 architecture within which some embodiments of the present disclosure operate is illustrated. The example computing system 100 comprises a project management and collaboration system 200, a plurality of software development tools 106A-106N, one or more collaboration tools 108, and a plurality of client devices 101A-101N, each communicatively connected through a communications network 102. Accordingly, user(s) (e.g., high-level users, business leaders (such as CEO, CFO, VP, etc.), project management (PgM) users, developers, team leaders, team members, etc.) may access the project management and collaboration system 200 via the communications network 102 using one or more of client devices 101A-101N. Project management and collaboration system 200 may comprise a deferred workspace identification management server 210 in communication with at least one data repository, such as a user-accessed application repository 215, an embedded application repository 220, and/or a deferred workspace identification repository 225. Such repository(ies) may be hosted by the deferred workspace identification management server 210 or otherwise hosted by devices in communication with the deferred workspace identification management server 210.

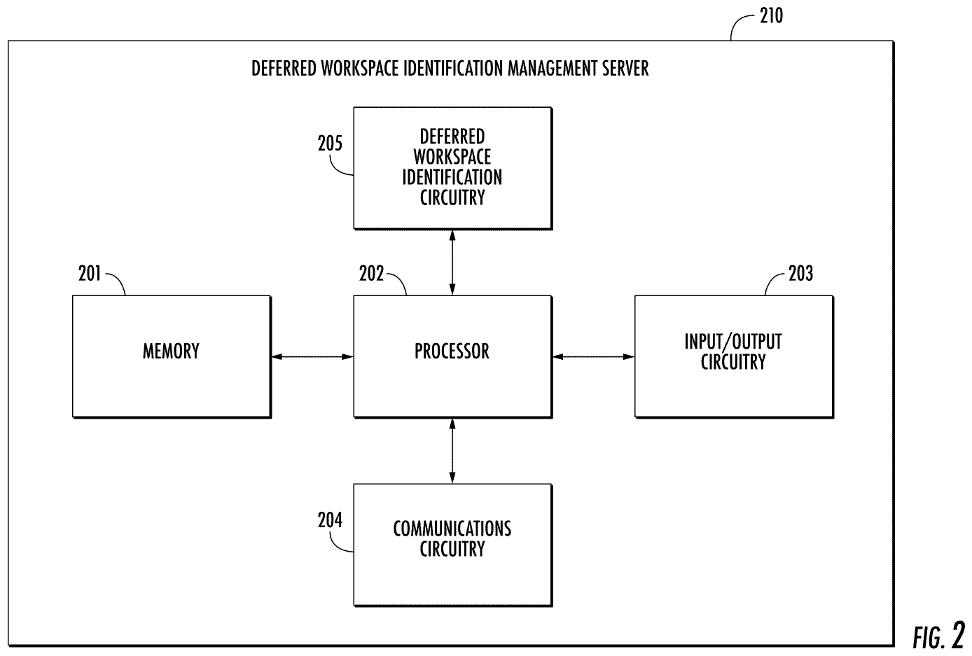

Deferred workspace identification management server 210 may include circuitry, networked processors, or the like configured to perform some or all of the deferred workspace identification-based processes described herein and may be any suitable network server and/or other type of processing device. In some embodiments, deferred workspace identification management server 210 may determine and transmit commands and instructions for rendering one or more deferred workspace identification interface components to client devices 101A-101N, using data from, for example, user-accessed application repository 215, embedded application repository 220, and/or deferred workspace identification repository 225. In this regard, the deferred workspace identification management server 210 may be embodied by any of a variety of devices, for example, the deferred workspace identification management server 210 may be embodied as a computer or a plurality of computers. For example, deferred workspace identification management server 210 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, deferred workspace identification management server 210 may be located remotely from the user-accessed application repository 215, embedded application repository 220, and/or deferred workspace identification repository 225, although in other embodiments, the deferred workspace identification management server 210 may comprise the user-accessed application repository 215, embedded application repository 220, and/or deferred workspace identification repository 225. The deferred workspace identification management server 210 may, in some embodiments, comprise several servers or computing devices performing interconnected and/or distributed functions. Despite the many arrangements contemplated herein, deferred workspace identification management server 210 is shown and described herein as a single computing device to avoid unnecessarily overcomplicating the disclosure.

Deferred workspace identification management server 210 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the project management and collaboration system 200.

The user-accessed application repository 215 may be stored by any suitable storage device configured to store some or all of the information described herein (e.g., memory 201 of the deferred workspace identification management server 210 or a separate memory system separate from the deferred workspace identification management server 210, such as one or more database systems, backend data servers, network databases, cloud storage devices, or the like provided by another device (e.g., online application or 3rd party provider), such as a Network Attached Storage (NAS) device or devices, or as a separate database server or servers. The user-accessed application repository 215 may comprise data received from the deferred workspace identification management server 210 (e.g., via a memory 201 and/or processor(s) 202), and the corresponding storage device may thus store this data. The user-accessed application repository 215 includes information accessed and stored by the deferred workspace identification management server 210 to facilitate the operations of the project management and collaboration system 200. As such, the user-accessed application repository 215 may include, for example, without limitation, data associated with the user-accessed application, such as user-accessed application data objects, project identifiers, workspace identifiers, team member identifier, team identifier, and/or the like.

The embedded application repository 220 may be stored by any suitable storage device configured to store some or all of the information described herein (e.g., memory 201 of the deferred workspace identification management server 210 or a separate memory system separate from the deferred workspace identification management server 210, such as one or more database systems, backend data servers, network databases, cloud storage devices, or the like provided by another device (e.g., online application or 3rd party provider), such as a Network Attached Storage (NAS) device or devices, or as a separate database server or servers. The embedded application repository 220 may comprise data received from the deferred workspace identification management server 210 (e.g., via a memory 201 and/or processor(s) 202), and the corresponding storage device may thus store this data. The embedded application repository 220 includes information accessed and stored by the embedded application repository 220 to facilitate the operations of the project management and collaboration system 200. As such, the embedded application repository 220 may include, for example, without limitation, data associated with the embedded application, such as embedded application object data, user identifiers, workspace identifiers, content data object identifiers, template identifiers, and/or the like.

The deferred workspace identification repository 225 may be stored by any suitable storage device configured to store some or all of the information described herein (e.g., memory 201 of the deferred workspace identification management server 210 or a separate memory system separate from the deferred workspace identification management server 210, such as one or more database systems, backend data servers, network databases, cloud storage devices, or the like provided by another device (e.g., online application or 3rd party provider), such as a Network Attached Storage (NAS) device or devices, or as a separate database server or servers. The deferred workspace identification repository 225 may comprise data received from the deferred workspace identification management server 210 (e.g., via a memory 201 and/or processor(s) 202), and the corresponding storage device may thus store this data. The deferred workspace identification repository 225 includes information accessed and stored by the deferred workspace identification management server 210 to facilitate the operations of the project management and collaboration system 200. As such, the deferred workspace identification repository 225 may include, for example, without limitation, data associated with the deferred workspace identification management server.

Software development tools 106A-106N may be any one or more underlying software development tools and/or project management tools (e.g., Jira Software®, Jira Services Management®, Jira Work Management®, etc.). In some embodiments, one or more software development tools 106A-106B may be enterprise tools or non-enterprise (e.g., third party) tools. In some non-limiting embodiments, a software development tool 106 is a user-accessed application.

Collaboration tool 108 may be any one or more underlying collaboration tools (e.g., Confluence®). In some embodiments, one or more collaboration tools 108 may be enterprise tools or non-enterprise (e.g., third party) tools. In some non-limiting embodiments, a collaboration tool 108 is an embedded application.

The client devices 101A-101N may be implemented as any computing device as defined above. Electronic data received by the deferred workspace identification management server 210 from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the deferred workspace identification interface component to a user and otherwise providing access to the project management and collaboration system 200. The depiction in FIG. 1 of “N” client devices is merely for illustration purposes. According to some embodiments, the client devices 101A-101N may be configured to display an interface on a display of the client device for viewing, creating, editing, and/or otherwise interacting with at least one deferred workspace identification interface component, which may be provided by the embedded application and/or the project management and collaboration system 200.

In embodiments where a client device 101A-101N is a mobile device, such as a smartphone or tablet, the client device 101A-101N may execute an “app” to interact with the project management and collaboration system 200. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the project management and collaboration system 200 via a web browser. As yet another example, the client devices 101A-101N may include various hardware or firmware designed to interface with the project management and collaboration system 200.

### Example Apparatus for Implementing Embodiments of the Present Disclosure

FIG. 2 illustrates an example deferred workspace identification management server 210 in accordance with at least some example embodiments of the present disclosure. In accordance with some example embodiments, deferred workspace identification management server 210 may include various components, modules, circuitries, or means, some or all of which may be also or instead be included in one or more client device(s) 101A-101N. In accordance with some example embodiments, deferred workspace identification management server 210 may be configured, using one or more of the sets of circuitry embodying memory 201, processor 202, input/output circuitry 203, communications circuitry 204, and/or deferred workspace identification circuitry 205 to execute and perform the operations described herein. In some embodiments, deferred workspace identification circuitry 205 is included in deferred workspace identification management server 210 and/or client device 101A, the circuitry configured to facilitate the functionality discussed herein regarding generating, outputting, and/or updating deferred workspace identification interface component(s), confirm workshop identification interface component(s), workspace publication confirmed interface component(s), and/or the like. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201-205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with deferred workspace identification management server 210, other elements of the deferred workspace identification management server 210 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, deferred workspace identification management server 210. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., deferred workspace identification management server 210, to carry out various functions in accordance with example embodiments of the present disclosure.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling deferred workspace identification management server 210 to carry out various functions in accordance with example embodiments discussed herein. For example, in at least some embodiments, memory 201 is configured to buffer data for processing by processor 202. Additionally or alternatively, in at least some embodiments, memory 201 is configured to store program instructions for execution by processor 202. Memory 201 may store information in the form of static and/or dynamic information. This stored information may be stored and/or used by deferred workspace identification management server 210 during the course of performing its functionalities.

Processor 202 may be embodied in a number of different ways and may, for example, include one or more processing devices configured to perform independently. Additionally or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as deferred workspace identification management server 210. The plurality of processors may be in operative communication with each other and may be collectively configured to perform one or more functionalities of deferred workspace identification management server 210 as described herein.

In an example embodiment, processor 202 is configured to execute instructions stored in the memory 201 or otherwise accessible to processor 202. Alternatively or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause deferred workspace identification management server 210 to perform one or more of the functionalities of deferred workspace identification management server 210 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 may be reduced when implemented also or instead as an end-user machine or other type of device designed for complex user interactions (i.e., client device 101). In some embodiments (like other components discussed herein), input/output circuitry 203 may even be eliminated from deferred workspace identification management server 210. Alternatively, in some embodiments, at least some aspects of input/output circuitry 203 may be embodied on an apparatus used by a user (e.g., team member, team leader, PgM, and/or the like) that is in communication with deferred workspace identification management server 210. Input/output circuitry 203 may be in communication with memory 201, communications circuitry 204, and/or any other component(s), such as via a bus. Although more than one input/output circuitry and/or other component can be included in deferred workspace identification management server 210, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with deferred workspace identification management server 210. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the deferred workspace identification management server 210 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of deferred workspace identification management server 210, such as via a bus.

In some embodiments, deferred workspace identification circuitry 205 may also or instead be included and configured to perform the functionality discussed herein related to generating, outputting, and/or updating deferred workspace identification interface component(s) and/or the like. Deferred workspace identification circuitry 205 includes hardware components and/or software configured to support interface component functionality, features, and/or services of the deferred workspace identification management server 210 and/or client device 101A. The deferred workspace identification circuitry 205 may utilize processing circuitry, such as the processor 202, to perform its corresponding operations, and may utilize memory 201 to store collected information. The deferred workspace identification circuitry 205 may send and/or receive data from user-accessed application repository 215, embedded application repository 220, and/or deferred workspace identification repository 225. In some implementations, the sent and/or received data may include identifier(s) (e.g., project identifier, team identifier, team member identifier, and/or the like), and associated data that is configured for association with, for example, generating, outputting, and/or updating deferred workspace identification interface component(s) and/or the like.

It should also be appreciated that, in some embodiments, the deferred workspace identification circuitry 205 may include a separate processor, specially configured field programmable gate array (FPGA), or application specific interface circuit (ASIC) to perform its corresponding functions. For example, in some embodiments, some or all of the functionality of deferred workspace identification circuitry 205 may be performed by processor 202. In this regard, some or all of the example processes and algorithms discussed herein can be performed by at least one processor 202 and/or deferred workspace identification circuitry 205. For example, non-transitory computer readable storage media can be configured to store firmware, one or more application programs, and/or other software, which include instructions and other computer-readable program code portions that can be executed to control processors of the components of deferred workspace identification management server 210 to implement various operations, including the examples shown herein. As such, a series of computer-readable program code portions may be embodied in one or more computer program products and can be used, with a device, deferred workspace identification management server 210, database, and/or other programmable apparatus, to produce the machine-implemented processes discussed herein. It is also noted that all or some of the information discussed herein can be based on data that is received, generated and/or maintained by one or more components of the deferred workspace identification management server 210, client device 101A, etc. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor or other programmable apparatus's circuitry to produce a machine, such that the computer, processor, or other programmable circuitry that execute the code on the machine creates the means for implementing various functions, including those described herein in connection with the components of deferred workspace identification management server 210.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

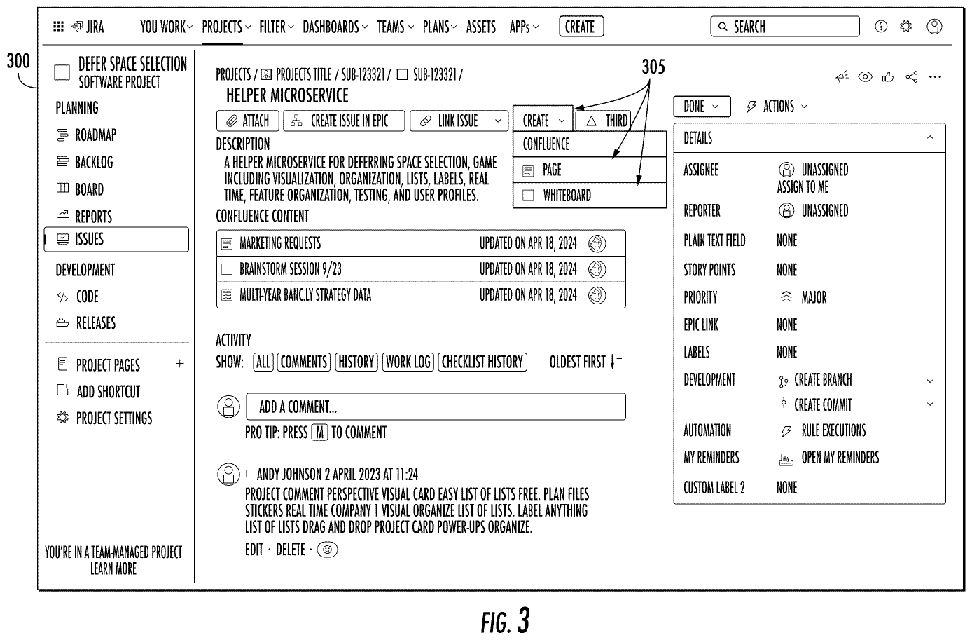

In various embodiments of the present disclosure, an apparatus (e.g., deferred workspace identification management server 210) may be configured to generate, output, and/or update a deferred workspace identification interface component in a project management and collaboration system 200. In some embodiments, the apparatus (e.g., deferred workspace identification management server 210) generates and outputs a deferred workspace identification interface component for rendering to an embedded application user interface displayed in association with the user-accessed application instance in response to detecting and/or receiving one or more embedded application content creation requests. For example, an embedded application content creation request is generated in response to a user interaction with a computing device wherein a user causes the computing device to generate an embedded application content creation request. In some embodiments, it is from user interaction with a user-accessed application user interface, as depicted in FIG. 3, that generates an embedded application content creation request. FIG. 3 illustrates an example user-accessed application user interface 300 structured in accordance with various embodiments of the subject disclosure. For example, a user of the user-accessed application interacts with the user-accessed application user interface 300 as depicted in FIG. 3 via verbal command, gesture, on-screen dynamics (e.g., soft key), or other user interaction with the computing device, causing the computing device to generate an embedded application content creation request.

In a non-limiting contextual example, as depicted in FIG. 3, the user interacts with, for example, one or more specific actuator buttons 305 (e.g., “Create”, “Page”, “Whiteboard”, and/or the like) rendered on a visual display of a computing device (e.g., client device 101A) in association with a user-accessed application user interface 300. In the example depicted in FIG. 3, the user is accessing a user-accessed application instance of Jira Software®. In particular, the user-accessed application user interface 300 of the user-accessed application instance is an “issue view” of Jira Software®, the issue view providing contextualized information regarding a service ticket or issue entitled “Helper Microservice” for a software project entitled “Defer Space Selection.”

Further to the non-limiting contextual example, FIG. 3 depicts the user having first selected the specific actuator button 305 corresponding to “Create.” That is, when selected by the user, the interaction with the depicted “Create” actuator button 305 may cause the client device 101A to generate an embedded application content creation request and/or generate an additional options request (e.g., a temporary code representative of the embedded application content creation request and/or the additional options request) that is transmitted to the deferred workspace identification management server 210 In the depicted example, such selection causes the client device to generate and transmit an additional options request to the deferred workspace identification management server 210, to which the deferred workspace identification management server 210, in response, causes a drop-down menu interface element depicting one or more additional specific actuator buttons 305 corresponding to choices for content creation the drop-down menu interface element depicts two specific actuator buttons 305, in particular, “Page” and “Whiteboard”. To indicate user intent to create a Confluence® Page, in the example depicted in FIG. 3, the user has interacted with the “Page” specific actuator button 305. In response to such user interaction, the computing device (e.g., client device 101A) generates and transmits an embedded application content creation request to an apparatus (e.g., deferred workspace identification management server 210). Such example, however, is for purposes of illustration and not of limitation and other suitable variations of facilitating the generation of an embedded application content creation request are also contemplated by this disclosure as will be apparent to one of ordinary skill in the art.

The apparatus (e.g., deferred workspace identification management server 210) receives the embedded application content creation request and causes generation of an embedded application content data object (e.g., a Confluence® page). For example, in some embodiments, the deferred workspace identification management server 210 may communicate with the embedded application server to cause the generation of such embedded application content data object. In addition, in some embodiments, the apparatus (e.g., deferred workspace identification management server 210) programmatically assigns the generated embedded application content data object to a workspace data structure. Such programmatic assignment (e.g., automatic selection) may remove friction perceived by users when forced to select a workspace data structure before even creating the embedded application content data object and/or reduce the number of users that drop off at such creation point. For example, as described herein, the apparatus (e.g., deferred workspace identification management server 210) may be configured to determine whether the underlying project associated with the user-accessed application instance (e.g., the Jira® project associated with the instance of Jira Software® accessed by the user) is already linked to a workspace data structure. As further described herein, in instances wherein the underlying project associated with the user-accessed application instance is already linked to a workspace data structure, in some embodiments, the apparatus (e.g., deferred workspace identification management server 210) may be configured to programmatically assign the generated embedded application content data object to such linked workspace data structure. In some embodiments, such linked workspace data structure may be a linked project workspace data structure such that the programmatic assignment may be determined based on a project identifier associated with the underlying project, such project identifier being included in the embedded application content creation request and/or otherwise accessed by the deferred workspace identification management server 210.

As further described herein, in instances wherein the underlying project associated with the user-accessed application instance is not already linked to a workspace data structure, in some embodiments, the apparatus (e.g., deferred workspace identification management server 210) may be configured to programmatically assign the generated embedded application content data object to a user workspace data structure associated with the user. In some embodiments, such programmatic assignment may be determined based on a user identifier associated with the underlying project and/or the user-accessed application instance, such user identifier being included in the embedded application content creation request and/or otherwise accessed by the deferred workspace identification management server 210.

In still other embodiments, the apparatus (e.g., deferred workspace identification management server 210) may be configured to programmatically assign the generated embedded application content data object to a user workspace data structure associated with the user as a holding workspace data structure regardless of whether the user-accessed application instance is already linked to a workspace data structure or not. That is, the apparatus (e.g., deferred workspace identification management server 210) may be configured to defer the selection, determination, and/or identification of a workspace data structure until later in the process and temporary store data associated with the generation of such embedded application content data object (e.g., during creation of the Confluence® page) in the user workspace data structure associated with the user.

In still other embodiments, the apparatus (e.g., deferred workspace identification management server 210) may be configured to programmatically assign the generated embedded application content data object to a workspace data structure based on information associated with the embedded application. In some embodiments, the apparatus (e.g., deferred workspace identification management server 210) may communicate with an embedded application server associated with the embedded application to determine, for example, a workspace data structure (e.g., having a workspace identifier) of the embedded application already associated with, linked to, or otherwise enabled with respect to a project of the user-accessed application. That is, in some embodiments, the programmatic assignment of the generated embedded application content data object to a workspace data structure may be based on relevant data from the embedded application and not the user-accessed application. In some embodiments, the apparatus (e.g., deferred workspace identification management server 210) may be configured to generate a deferred workspace identification interface component comprising an identification of the workspace data structure and output the deferred workspace identification interface component for rendering to an embedded application user interface displayed in association with the user-accessed application instance. For example, FIGS. 4A and 4B illustrate example deferred workspace identification interface components 401 rendered to embedded application user interfaces 400 structured in accordance with various embodiments of the subject disclosure. Continuing with the non-limiting contextual example from above and as depicted in FIGS. 4A and 4B, a deferred workspace identification interface component 401 comprising an identification of the workspace data structure (e.g., programmatically assigned workspace data structure) may be generated and output by the deferred workspace identification management server 210 for rendering to an embedded application user interface 400 (e.g., as indicated by the “Powered by Confluence”) displayed in association with the user-accessed application instance. As depicted in FIG. 4A, in some embodiments wherein the underlying project associated with the user-accessed application instance is already linked to a workspace data structure (e.g., a linked project workspace data structure), the deferred workspace identification interface component 401 comprises an identification of the project workspace data structure (e.g., “Confluence Space—Better Together—Defer Space Selection”) already linked to the underlying project. As depicted in FIG. 4B, in some embodiments wherein the underlying project associated with the user-accessed application instance is not already linked to a workspace data structure, the deferred workspace identification interface component 401 comprises an identification of a user workspace data structure associated with the user (e.g., “Personal Space—Andy Johnson”). For example, such user workspace data structure may be a personal workspace or personal container associated with the user, such personal workspace or personal container being a workspace associated with the underlying application of the embedded application (e.g., Confluence®) that a user may use to, for example, store data that the user is working on individually, for personal to-do lists, for publishing content before moving to another shared workspace, and/or the like.

In some embodiments, as depicted in FIGS. 4A and 4B, the embedded application user interface 400 is an embedded application editor user interface configured for receiving user edits to the embedded application content data object. For example, such embedded application editor user interface may be configured to enable the user to edit and/or view the embedded instance of the embedded application (e.g., an embedded page of Confluence®), allowing the user to create, edit, and/or view the embedded instance of the embedded application within the user-accessed application instance (e.g., Jira Software®). In some embodiments, the embedded application editor user interface may comprise tools for modifying the embedded application, tools for embedded application template selection, and/or be configured to import data from other sources as depicted in FIGS. 4A and 4B. As further depicted in FIGS. 4A and 4B, in some embodiments, the embedded application editor user interface may include an editable title interface (e.g. “Enhanced User Profile—Testing Requirements”) and/or editable body interface for the embedded application content data object (e.g., the created Confluence® page).

In some embodiments, the embedded application user interface 400 comprises a publication actuator button 402 (e.g., “Publish” button) for which user interaction with causes the client device 101A to generate and transmit a publish embedded application content data object request to the deferred workspace identification management server 210. The deferred workspace identification management server 210 may be configured to generate and output a confirm workspace identification interface component as described with respect to FIGS. 5A and 5B herein.

Returning to FIGS. 4A and 4B, with respect to the embedded application user interface 400 displayed in association with the user-accessed application instance, access to the embedded application (e.g., via a data-driven connection) is embedded within the user-accessed application user interface 300 of the user-accessed application. For example, as depicted in FIGS. 4A and 4B, the embedded application user interface 400 may display in a modal experience via the user-accessed application user interface 300. In other words, the functionality of the embedded application is available to the user directly within the user-accessed application user interface 300. This embedded application user interface 400 displayed in association with and/or through the user-accessed application provides access to the functionality of the embedded application via an established data-driven connection.

Additionally or alternatively, as described herein, the one or more embedded application content creation requests may comprise any one or more data points or unique identifiers that may be necessary to cull relevant information in order to programmatically assign the generated embedded application content data object to a workspace data structure and generate the deferred workspace identification interface component 401. To provide context, in a non-limiting example, the underlying project associated with the user-accessed application instance (e.g., the Jira® project associated with the instance of Jira Software® accessed by the user) may be associated with a project identifier, which may, in turn, be used to, for example, determine whether a workspace identifier is associated with the project identifier. In some embodiments, the user may have or be associated with a user identifier in the project management and collaboration system 200 and/or the embedded application. In some embodiments, the embedded application content creation request may comprise such unique identifier(s). In some other embodiments, the apparatus (e.g., deferred workspace identification management server 210) may be configured to access and/or determine such unique identifier(s). Other non-limiting examples of such unique identifier(s) include team identifier, team member identifier, workspace identifier, and/or the like.

In some embodiments, for example as depicted in FIGS. 4A and 4B, the deferred workspace identification interface component 401 is configured to provide an interactive workspace data structure input interface element, the interactive workspace data structure input interface element configured to enable user input of at least one changed workspace data structure. For example, in some embodiments, the interactive workspace data structure input interface element comprises a drop-down menu, the drop-down menu comprises a workspace data structure suggestion set (e.g., exposing a list of potential workspace data structures to which the embedded application content data object (e.g., a Confluence® page) may be re-assigned), and the workspace data structure suggestion set comprises the programmatically assigned workspace data structure and one or more potential changed workspace data structures. Such potential changed workspace data structures of the workspace data structure suggestion set may include but is not limited to, for example, a project workspace data structure linked to or otherwise enabled with respect to the underlying project, a user workspace data structure linked to the user, a team workspace data structure linked to a team associated with the underlying project, and/or the like.

For example, in some embodiments, the workspace data structure suggestion set may be determined and/or populated with any number of potential changed workspace data structures based on the deferred workspace identification management server 210 generating a query that is submitted to one or more data repositories, such as a user-accessed application repository 215, an embedded application repository 220, and/or a deferred workspace identification repository 225. Such query may be based on, for example, one or more of a team member identifier, a team identifier, a user identifier, a project identifier, a workspace identifier, and/or the like. In such embodiments, the one or more potential changed workspace data structures returned by the query may form the workspace data structure suggestion set. In other words, in some embodiments, determining a workspace data structure suggestion set may comprise generating a query based on at least one of the one or more identifiers, submitting the query to one or more data repositories, and assigning the one or more potential changed workspace data structures returned by the query to the workspace data structure suggestion set.

In some embodiments, one or more machine learning models designed to leverage artificial intelligence may be used in connection with the determination of the one or more potential changed workspace data structures of a workspace data structure suggestion set. For example, the deferred workspace identification management server 210 may be configured to draw from a range of information sources that can be supplied to the machine learning model(s) in order to make contextual suggestions or predictions as to potential changed workspace data structures. For example, any one or more of the data described herein (e.g., team member data, team identifiers, team member identifiers, user identifiers, project identifiers, workspace identifiers, workspace data structure usage data, and/or the like) and correlations thereof can be used in connection with the machine learning model. Moreover, in some embodiments, the machine learning based model employed by the apparatus can be trained using such team member data, team identifiers, team member identifiers, user identifiers, project identifiers, workspace identifiers, workspace data structure usage data, and/or the like. For example, in some embodiments, the apparatus (e.g., via deferred workspace identification circuitry 205) implements an unsupervised learning structure, a supervised learning structure, a reinforcement learning structure, a deep learning structure, and/or the like for programmatically determining correlations of the varied data and data formats to make contextual suggestions or predictions as to at least the workspace data structure suggestion set.

Turning to FIGS. 5A and 5B, FIGS. 5A and 5B illustrate example confirm workspace identification interface components 500 structured in accordance with various embodiments of the subject disclosure. For example, the depicted confirm workspace identification interface component 500 of FIGS. 5A and 5B are examples of a confirm workspace identification interface component 500 that is generated and caused to be rendered to the embedded application user interface 400 that is displayed in association with the user-accessed application (e.g., within the user-accessed application user interface 300) in response to a user interacting with the publication actuator button 402 of the embedded application user interface 400 (e.g., an embedded application editor user interface).

The depicted confirm workspace identification interface component 500 in FIGS. 5A and 5B comprises an identification of the workspace data structure to which the generated embedded application content data object is being stored. Such workspace data structure, as described herein, may be the programmatically assigned workspace data structure (e.g., based on the underlying project already being linked to a project workspace data structure or based on a user workspace data structure associated with the user) or optionally a potential changed workspace data structure as selected from the optional interactive workspace data structure input interface element (e.g., configured to enable user input of at least one changed workspace data structure) as described herein with respect to the deferred workspace identification interface component 401. As depicted in the non-limiting example of FIG. 5A, the workspace data structure is identified as the project workspace data structure, “Confluence Space—Better Together—Defer Space Selection” while the non-limiting example of FIG. 5B depicts the workspace data structure identified as the user workspace data structure, “Personal Space—Andy Johnson”.

In some embodiments, the confirm workspace identification interface component 500 is configured to provide an interactive workspace data structure input interface element 501, the interactive workspace data structure input interface element 501 configured to enable user input of at least one changed user workspace data structure. For example in some embodiments, selection of the interactive workspace data structure input interface element 501 may trigger user input, such as description of a workspace data structure or workspace identifier, causing the client device to generate and transmit a change workspace data structure request (e.g., comprising a workspace identifier) to the deferred workspace identification management server 210. In response to receiving such a change workspace data structure request, the deferred workspace identification management server 210 may be configured to programmatically assign the embedded application content data object to a changed workspace data structure associated with the workspace identifier. In other words, the deferred workspace identification management server 210 may be configured to update the workspace data structure to a changed workspace data structure as identified by the user.

To confirm the identification of the workspace data structure (e.g., as programmatically assign or as changed/updated by the user) to which the generated embedded application content data object is being stored, in some embodiments, in some embodiments, the confirm workspace identification interface component 500 comprises a publication actuator button 502 (e.g., “Publish” button) for which user interaction with causes the client device 101A to generate and transmit a confirm embedded application content data object publication request to the deferred workspace identification management server 210. The deferred workspace identification management server 210 may be configured to generate and output a workspace publication confirmed interface component comprising an identification of the workspace data structure (e.g., confirmed) for rendering to the embedded application user interface 400 in response to receiving a confirm embedded application content data object publication request.

Turning to FIGS. 6A and 6B, FIGS. 6A and 6B each illustrate an example workspace publication confirmed interface component 600 structured in accordance with various embodiments of the subject disclosure. For example, the depicted workspace publication confirmed interface component 600 of FIGS. 6A and 6B is a workspace publication confirmed interface component 600 that is generated and caused to be rendered to the embedded application user interface 400 that is displayed in association with the user-accessed application (e.g., within the user-accessed application user interface 300) in response to a user interacting with the publication actuator button 502 of the confirm workspace identification interface component 500. The workspace publication confirmed interface component 600 conveys confirmation that the generated embedded application content data object was successfully published to the workspace data structure. For example, in the non-limiting contextual example depicted in FIG. 6A, the workspace publication confirmed interface component 600 indicates that the Confluence® page entitled “Enhanced User Profile—Testing Requirements” was published to the workspace data structure linked to the underlying project—“Confluence Space—Better Together—Defer Space Selection” (e.g., project workspace data structure). In the non-limiting contextual example depicted in FIG. 6B, the workspace publication confirmed interface component 600 indicates that the Confluence® page entitled “Enhanced User Profile—Testing Requirements” was published to the personal workspace of Andy Johnson (e.g., user workspace data structure).

In some embodiments, such publication is an indication of accessibility type. For example, in some embodiments, the embedded application content data object is assigned a first accessibility type when generated. For example, when first generated and unless and until the user “publishes” the embedded application content data object, the first accessibility type may be private, draft, or otherwise only accessible to the user. For example, the data associated with generating and/or creating the embedded application content data object may be stored in the programmatically assigned workspace data structure but such data is not accessible to others while private or otherwise not “published”. In some embodiments, once “published”, the deferred workspace identification management server 210 may cause updating of the first accessibility type to a second accessibility type, for example, such that the embedded application content data object (e.g., generated Confluence® page) is public or otherwise accessible to a defined list of users. In still other embodiments, for example, when the embedded application content data object is temporarily programmatically assigned to a user workspace data structure until the user confirms a workspace data structure, once “published”, the data associated with the generated embedded application content data object is transferred to and saved in the workspace data structure as selected and/or confirmed by the user and otherwise becomes public or accessible to a defined list of users. In some embodiments, this may be the user workspace data structure and in other embodiments, this may be a changed workspace data structure as identified by the user.

Such depicted examples of deferred workspace identification interface components, embedded application user interfaces, user-accessed application user interfaces, confirm workspace identification interface components, interactive workspace data structure input interface elements, workspace publication confirmed interface components, actuator buttons, and/or the like are for purposes of illustration and not of limitation and other suitable variations of depicting the various interfaces, interface components, interface elements, and actuator buttons are also contemplated by this disclosure as will be apparent to one of ordinary skill in the art.

### Example Operations Performed

Having described example apparatuses and systems and exemplary circuitry in accordance with various embodiments of the present disclosure, example process of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. It will further be appreciated that the example apparatuses, systems, devices, and/or computer program products may proceed to generate, output, and/or update deferred workspace identification interface components and/or the like in a project management and collaboration system 200 in a number of different ways.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

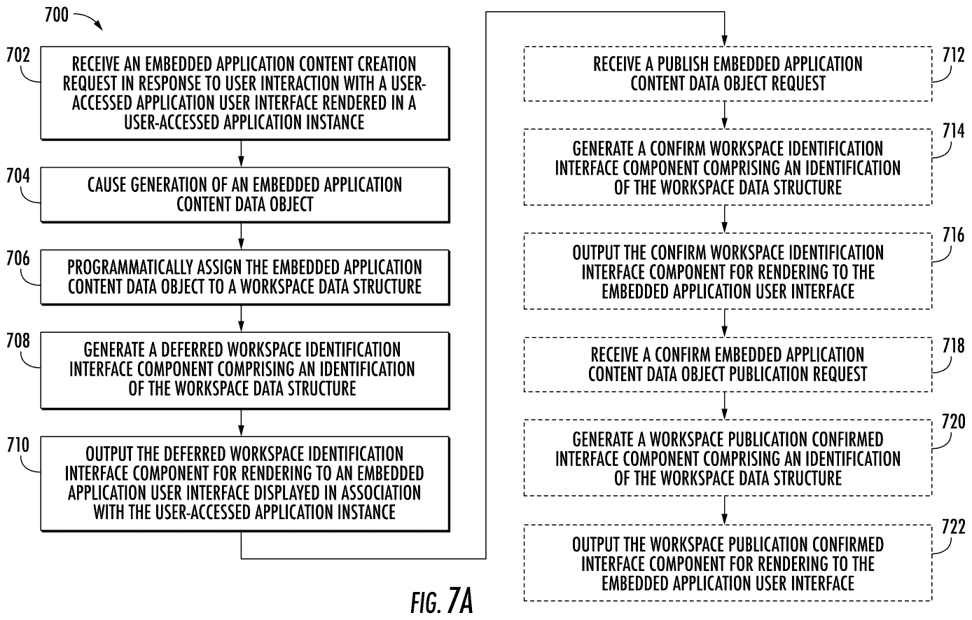

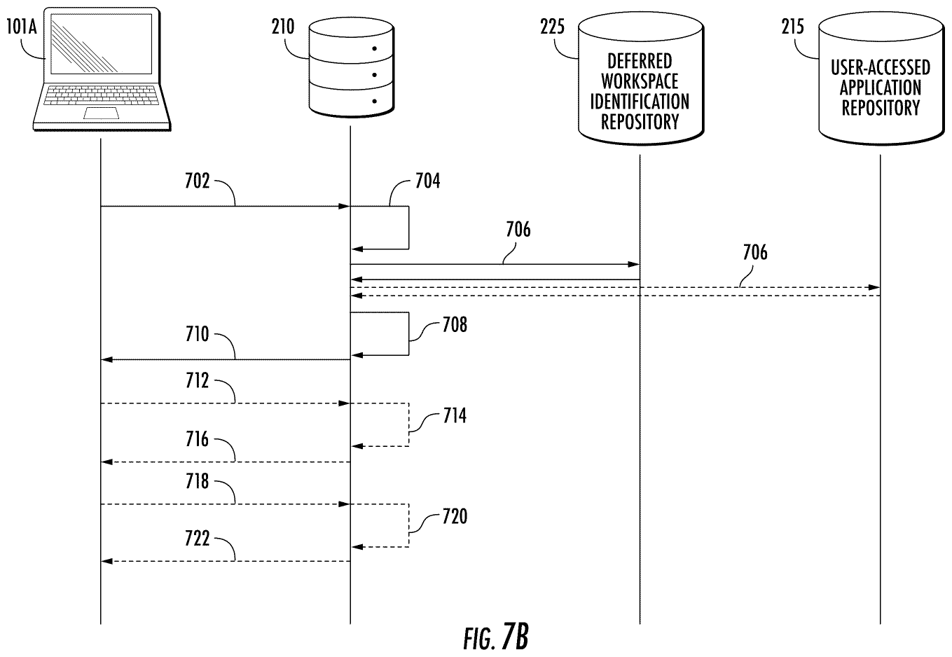

FIG. 7A is a flowchart broadly illustrating a series of operations or process blocks that are executed or performed to output a deferred workspace identification interface component for rendering to an embedded application user interface displayed in association with a user-accessed application instance in accordance with some example embodiments of the present disclosure. In some embodiments, the method 700 is embodied by computer program code stored on a non-transitory computer-readable storage medium of a computer program product configured for execution to perform the process as depicted and described. In this regard, in some such embodiments, the deferred workspace identification management server 210 is specially configured by computer-coded instructions (e.g., computer program instructions) stored thereon, for example in the memory 201 and/or another component depicted and/or described herein and/or otherwise accessible to the deferred workspace identification management server 210, for performing the operations as depicted and described. Alternatively, or additionally, in some embodiments, the method 700 is performed by one or more specially configured computing devices, such as the deferred workspace identification management server 210 alone or in communication with one or more other component(s), device(s), system(s), and/or the like. For purposes of simplifying the description, the method 700 is described as performed by and from the perspective of the deferred workspace identification management server 210. In this regard, performance of the operations may invoke one or more of memory 201, processor 202, input/output circuitry 203, communications circuitry 204, and/or deferred workspace identification circuitry 205.

In the embodiment illustrated in FIG. 7A, the flowchart illustrates method 700 which begins at block 702, which includes receiving an embedded application content creation request. For example, the deferred workspace identification management server 210 may include means, such as the processor 202, communications circuitry 204, deferred workspace identification circuitry 205, or the like, for receiving an embedded application content creation request. In some embodiments, the embedded application content creation request is received in response to user interaction with user-accessed application user interface displayed in association with a user-accessed application. In still further embodiments, the embedded application content creation request is associated with one or more unique identifiers, such as a project identifier and/or a user identifier associated with the request. In a non-limiting contextual example, a user may be interacting with an issue view of a user-accessed application (e.g., Jira Software®) and such user may interact with one or more elements of the user-accessed application user interface to indicate such embedded application content creation request. For example, the user may interact with one or more specific actuator buttons to indicate a desire to create an embedded application content data object (e.g., a Confluence® page) within the user-accessed application (e.g., Jira Software®). That is, the user indicates a request for a data-driven connection to be established and/or otherwise associate an embedded application content data object with the user-accessed application that enables interoperability between the user-accessed application and the embedded application content data object of the embedded application. In this regard, in some embodiments, the data-driven connection enables functionality of the embedded application to be performed via the user-accessed application.

At block 704, the deferred workspace identification management server 210 includes means, such as the memory 201, processor 202, input/output circuitry 203, communications circuitry 204, and/or deferred workspace identification circuitry 205, or a combination thereof, to cause generation of an embedded application content data object. For example, in some embodiments, the deferred workspace identification management server 210 generates the embedded application content data object itself. In other embodiments, the deferred workspace identification management server 210 transmits instructions in accordance with embedded application content creation request to one or more other servers (e.g., microservices) running the embedded application and/or another computing device in order to generate embedded application content data object.

At block 706, the method 700 further includes programmatically assigning the embedded application content data object to a workspace data structure. For example, the deferred workspace identification management server 210 may include means, such as the processor 202, communications circuitry 204, deferred workspace identification circuitry 205, or the like, for programmatically assigning the embedded application content data object to a workspace data structure. For example, in some embodiments, the embedded application content creation request received in block 702 (or otherwise accessed by the deferred workspace identification management server 210) comprises a project identifier associated with the user-accessed application instance such that programmatically assigning the embedded application content data object in block 706 comprises assigning the embedded application content data object to a project workspace data structure in an instance wherein the project identifier is associated with such project workspace data structure. In some embodiments, block 706 comprises programmatically assigning the embedded application content data object to a user workspace data structure associated with a user identifier of the user in an instance wherein the project identifier received in block 702 or otherwise accessed by the deferred workspace identification management server 210 is not already associated with a project workspace data structure. For example, in some embodiments, the embedded application content creation request received in block 702 (or otherwise accessed by the deferred workspace identification management server 210) comprises a user identifier associated with the user. In some embodiments, block 706 may include the deferred workspace identification management server 210 generating a query that is submitted to a data repository, such as a deferred workspace identification repository 225, a user-accessed application repository 215, and/or an embedded application repository 220. Such a query may be based on, for example, a project identifier, a user identifier, a team member identifier, a team identifier, and/or the like. In other embodiments, block 706 may include the deferred workspace identification management server 210 generating a request and/or query that is submitted to the embedded application repository 220, such request and/or query configured to return identification of a workspace data structure based on, for example, the project identifier.

In still other embodiments, the deferred workspace identification management server 210 may be configured to programmatically assign the generated embedded application content data object to a user workspace data structure associated with the user as a holding workspace data structure regardless of whether the user-accessed application instance is already linked to a workspace data structure or not. That is, the deferred workspace identification management server 210 may be configured to defer the selection, determination, and/or identification of a workspace data structure until later in the process and programmatically assign the generated embedded application content data object to a user workspace data structure in order to temporary store data associated with the generation of such embedded application content data object (e.g., during creation of the Confluence® page) in the user workspace data structure associated with the user.

At block 708, the deferred workspace identification management server 210 includes means, such as the memory 201, processor 202, input/output circuitry 203, communications circuitry 204, and/or deferred workspace identification circuitry 205, or a combination thereof, to generate a deferred workspace identification interface component comprising an identification of the workspace data structure (e.g., the workspace data structure programmatically assigned in block 706).

At block 710, the deferred workspace identification management server 210 includes means, such as the memory 201, processor 202, input/output circuitry 203, communications circuitry 204, and/or deferred workspace identification circuitry 205, or a combination thereof, to output the deferred workspace identification interface component for rendering to an embedded application user interface, for example, as depicted in FIGS. 4A and 4B, the embedded application user interface displayed in association with the user-accessed application instance. For example, in some embodiments, the embedded application user interface is an embedded application editor user interface configured for receiving user edits to the embedded application content data object as depicted in FIGS. 4A and 4B.

In some embodiments, the deferred workspace identification interface component is optionally configured to provide an interactive workspace data structure input interface element, the interactive workspace data structure input interface element configured to enable user input of at least one changed workspace data structure. For example, in some embodiments, the interactive workspace data structure input interface element comprises a drop-down menu, the drop-down menu comprising a workspace data structure suggestion set and the workspace data structure suggestion set comprising the workspace data structure programmatically assigned in block 706 and one or more potential changed workspace data structures. That is the drop-down menu may include the currently selected workspace data structure that was programmatically assigned in block 706 and a list of potential workspace data structures to which the embedded application content data object may be re-assigned. Such potential changed workspace data structures of the workspace data structure suggestion set may include but is not limited to, for example, a project workspace data structure linked to the underlying project, a user workspace data structure linked to the user, a team workspace data structure linked to a team associated with the underlying project, and/or the like.

For example, in some embodiments, the workspace data structure suggestion set may be determined and/or populated with any number of potential changed workspace data structures based on the deferred workspace identification management server 210 generating a query that is submitted to one or more data repositories, such as a user-accessed application repository 215, an embedded application repository 220, and/or a deferred workspace identification repository 225. Such query may be based on, for example, one or more of a team member identifier, a team identifier, a user identifier, a project identifier, a workspace identifier, and/or the like. In such embodiments, the one or more potential changed workspace data structures returned by the query may form the workspace data structure suggestion set. In other words, in some embodiments, determining a workspace data structure suggestion set may comprise generating a query based on at least one of the one or more identifiers, submitting the query to one or more data repositories, and assigning the one or more potential changed workspace data structures returned by the query to the workspace data structure suggestion set.

In some embodiments, one or more machine learning models designed to leverage artificial intelligence may be used in connection with the determination of the one or more potential changed workspace data structures of a workspace data structure suggestion set. For example, the deferred workspace identification management server 210 may be configured to draw from a range of information sources that can be supplied to the machine learning model(s) in order to make contextual suggestions or predictions as to potential changed workspace data structures. For example, any one or more of the data described herein (e.g., team member data, team identifiers, team member identifiers, user identifiers, project identifiers, workspace identifiers, workspace data structure usage data, and/or the like) and correlations thereof can be used in connection with the machine learning model. Moreover, in some embodiments, the machine learning based model employed by the apparatus can be trained using such team member data, team identifiers, team member identifiers, user identifiers, project identifiers, workspace identifiers, workspace data structure usage data, and/or the like. For example, in some embodiments, the apparatus (e.g., via deferred workspace identification circuitry 205) implements an unsupervised learning structure, a supervised learning structure, a reinforcement learning structure, a deep learning structure, and/or the like for programmatically determining correlations of the varied data and data formats to make contextual suggestions or predictions as to at least the workspace data structure suggestion set.

Returning to FIG. 7A, at optional block 712, the deferred workspace identification management server 210 includes means, such as the memory 201, processor 202, input/output circuitry 203, communications circuitry 204, and/or deferred workspace identification circuitry 205, or a combination thereof, to optionally receive a publish embedded application content data object request.

At optional block 714, the deferred workspace identification management server 210 includes means, such as the memory 201, processor 202, input/output circuitry 203, communications circuitry 204, and/or deferred workspace identification circuitry 205, or a combination thereof, to optionally generate a confirm workspace identification interface component comprising an identification of the workspace data structure. For example, the workspace data structure identified may be the programmatically assigned workspace data structure if the user did not change such workspace data structure in block 710.

At optional block 716, the deferred workspace identification management server 210 includes means, such as the memory 201, processor 202, input/output circuitry 203, communications circuitry 204, and/or deferred workspace identification circuitry 205, or a combination thereof, to optionally output the confirm workspace identification interface component for rendering to the embedded application user interface, for example, as depicted in FIGS. 5A and 5B.

In some embodiments, the confirm workspace identification interface component output in block 716 is optionally configured to provide an interactive workspace data structure input interface element, the interactive workspace data structure input interface element configured to enable user input of at least one changed user workspace data structure. For example, the deferred workspace identification management server 210 may be configured to receive a change workspace data structure request comprising a workspace identifier and programmatically re-assign the embedded application content data object to a changed workspace data structure associated with the workspace identifier. This provides the user with an optional opportunity to change the programmatically assigned workspace.

Returning to FIG. 7A, at optional block 718, the deferred workspace identification management server 210 includes means, such as the memory 201, processor 202, input/output circuitry 203, communications circuitry 204, and/or deferred workspace identification circuitry 205, or a combination thereof, to optionally receive a confirm embedded application content data object publication request.

At optional block 720, the deferred workspace identification management server 210 includes means, such as the memory 201, processor 202, input/output circuitry 203, communications circuitry 204, and/or deferred workspace identification circuitry 205, or a combination thereof, to optionally generate a workspace publication confirmed interface component comprising an identification of the workspace data structure. For example, the workspace data structure identified may be the programmatically assigned workspace data structure if the user did not change such workspace data structure in block 710 or optional block 716.

At optional block 722, the deferred workspace identification management server 210 includes means, such as the memory 201, processor 202, input/output circuitry 203, communications circuitry 204, and/or deferred workspace identification circuitry 205, or a combination thereof, to optionally output the workspace publication confirmed interface component for rendering to the embedded application user interface, for example, as depicted in FIGS. 6A and 6B.

FIG. 7B is a signal diagram of an example data flow represented by method 700. That is, FIG. 7B illustrates an example signal diagram illustrating data flow interactions between a client device, a deferred workspace identification management server, and one or more data repositories when outputting a deferred workspace identification interface component in accordance with one embodiment. Method 700 is described as being performed by a client device 101A, a deferred workspace identification management server 210, a deferred workspace identification repository 225, and optionally a user-accessed application repository 215. These may be similar to those previously discussed with regards to FIG. 1.

FIGS. 7A and 7B thus illustrate flowcharts and signal diagrams describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 201 of the deferred workspace identification management server 210 and executed by a processor 202 of the deferred workspace identification management server 210. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of the present disclosure or of what may be claimed, but rather as description of features specific to particular embodiments of present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for outputting a deferred workspace identification interface component in a project management and collaboration system, the apparatus comprising at least one processor, and at least one memory including program code, the at least one memory and the program code configured to, with the at least one processor, cause the apparatus to at least:
receive an embedded application content creation request in response to user interaction with a user-accessed application user interface rendered in a user-accessed application instance;
cause generation of an embedded application content data object;
programmatically assign the embedded application content data object to a workspace data structure;
generate a deferred workspace identification interface component comprising an identification of the workspace data structure; and
output the deferred workspace identification interface component for rendering to an embedded application user interface displayed in association with the user-accessed application instance.

2. The apparatus of claim 1, wherein the embedded application content creation request comprises a project identifier associated with the user-accessed application instance.

3. The apparatus of claim 2, wherein programmatically assigning the embedded application content data object comprises:
in an instance wherein the project identifier is associated with a project workspace data structure, assigning the embedded application content data object to the project workspace data structure; and
in an instance wherein the project identifier is not associated with a project workspace data structure, assign the embedded application content data object to a user workspace data structure.

4. The apparatus of claim 1, wherein the deferred workspace identification interface component is configured to provide an interactive workspace data structure input interface element, the interactive workspace data structure input interface element configured to enable user input of at least one changed workspace data structure.

5. The apparatus of claim 4, wherein:
the interactive workspace data structure input interface element comprises a drop-down menu,
the drop-down menu comprises a workspace data structure suggestion set, and
the workspace data structure suggestion set comprises the workspace data structure and one or more potential changed workspace data structures.

6. The apparatus of claim 1, wherein the embedded application user interface is an embedded application editor user interface configured for receiving user edits to the embedded application content data object.

7. The apparatus of claim 1, wherein the at least one memory and the program code are further configured to, with the at least one processor, cause the apparatus to at least:
receive a publish embedded application content data object request;
generate a confirm workspace identification interface component comprising an identification of the workspace data structure; and
output the confirm workspace identification interface component for rendering to the embedded application user interface.

8. The apparatus of claim 7, wherein the confirm workspace identification interface component is configured to provide an interactive workspace data structure input interface element, the interactive workspace data structure input interface element configured to enable user input of at least one changed user workspace data structure.

9. The apparatus of claim 8, wherein the at least one memory and the program code are further configured to, with the at least one processor, cause the apparatus to at least:
receive a change workspace data structure request comprising a workspace identifier; and
programmatically assign the embedded application content data object to a changed workspace data structure associated with the workspace identifier.

10. The apparatus of claim 7, wherein the at least one memory and the program code are further configured to, with the at least one processor, cause the apparatus to at least:
receive a confirm embedded application content data object publication request;
generate a workspace publication confirmed interface component comprising an identification of the workspace data structure; and
output the workspace publication confirmed interface component for rendering to the embedded application user interface.

11. The apparatus of claim 10, wherein the embedded application content data object is assigned a first accessibility type when generated, and wherein the at least one memory and the program code are further configured to, with the at least one processor, cause the apparatus to at least:
cause updating of the first accessibility type to a second accessibility type.

12. A computer-implemented method for outputting a deferred workspace identification interface component in a project management and collaboration system, the method comprising:
receiving an embedded application content creation request in response to user interaction with a user-accessed application user interface rendered in a user-accessed application instance;
causing generation of an embedded application content data object;
programmatically assigning the embedded application content data object to a workspace data structure;
generating a deferred workspace identification interface component comprising an identification of the workspace data structure;
outputting the deferred workspace identification interface component for rendering to an embedded application user interface displayed in association with the user-accessed application instance;
receiving a publish embedded application content data object request;
generating a confirm workspace identification interface component comprising an identification of the workspace data structure; and
outputting the confirm workspace identification interface component for rendering to the embedded application user interface.

13. The method of claim 12, wherein the embedded application content creation request comprises a project identifier associated with the user-accessed application instance.

14. The method of claim 13, wherein programmatically assigning the embedded application content data object comprises:
in an instance wherein the project identifier is associated with a project workspace data structure, assigning the embedded application content data object to the project workspace data structure; and
in an instance wherein the project identifier is not associated with a project workspace data structure, assign the embedded application content data object to a user workspace data structure.

15. The method of claim 12, wherein the deferred workspace identification interface component is configured to provide an interactive workspace data structure input interface element, the interactive workspace data structure input interface element configured to enable user input of at least one changed workspace data structure.

16. The method of claim 15, wherein:
the interactive workspace data structure input interface element comprises a drop-down menu,
the drop-down menu comprises a workspace data structure suggestion set, and
the workspace data structure suggestion set comprises the workspace data structure and one or more potential changed workspace data structures.

17. The method of claim 12, wherein the embedded application user interface is an embedded application editor user interface configured for receiving user edits to the embedded application content data object.

18. The method of claim 12, wherein the confirm workspace identification interface component is configured to provide an interactive workspace data structure input interface element, the interactive workspace data structure input interface element configured to enable user input of at least one changed user workspace data structure.

19. A computer program product, stored on a non-transitory computer readable storage medium, comprising instructions that when executed by one or more processors cause the one or more processors to:
receive an embedded application content creation request in response to user interaction with a user-accessed application user interface rendered in a user-accessed application instance;
cause generation of an embedded application content data object;
programmatically assign the embedded application content data object to a workspace data structure;
generate a deferred workspace identification interface component comprising an identification of the workspace data structure; and
output the deferred workspace identification interface component for rendering to an embedded application user interface displayed in association with the user-accessed application instance, wherein the embedded application user interface is associated with an embedded application instance and wherein the user-accessed application instance and the embedded application instance define separate executable code bases.

20. The computer program product of claim 19, wherein the user-accessed application instance defines a first executable code base that performs a particular first set of functions and is configured to provide a second set of functions associated with the embedded application instance embodied by a second executable code base.
